(19) United States
(12) Patent Application Publication
(10) Pub. No.: US 2006/0281508 A1
(43) Pub. Date: Dec. 14, 2006

(54) Racing game and method

(75) Inventors: Stephen Carney, Barrington, RI (US); Aza Pitchenik, West Warwick, RI (US)

Correspondence Address: WILLIAMS MULLEN, 8270 GREENSBORO DRIVE, SUITE 700, MCLEAN, VA, 22102, US

(73) Assignee: GTECH Rhode Island Corporation

(21) Appl. No.: 11/140,403

(22) Filed: May 27, 2005

(51) Int. Cl. A63F 13/00

(52) U.S. Cl. 463/6

(57) ABSTRACT

Draw-type racing animation games are provided according to the present invention by selecting a random outcome to a race and working backwards to the starting point of a race, while randomly selecting events for each racing entity at each backwards step, as well as randomly selecting camera views of the race. Each random event and camera view is stored so that, when the race has been completely run in reverse, the system of the present invention can then render and display the race in forward direction so as to display a unique race every time.

### FIELD OF THE INVENTION

The present invention relates to racing games, and more particularly, to a racing game system and method in which a player or players can experience animated video race simulations at different locations and wherein no two races are ever alike.

### BACKGROUND OF THE INVENTION

Video games provide social entertainment in arcades, restaurants and bars, for example. Casino-type games, such as video poker and draw-type video games, where there is a finishing order or draw, are types of video games that have become increasingly popular. Through improvements in animation, game processing and networking, it is now possible to watch animated races such as auto races, horse races, and dog races, for example, at several locations while optionally placing wagers on the animated event.

Prior and current systems offering such races typically create a series of animated races with a variety of outcomes, wherein the series is stored in a pool of animated races for random selection. When a particular race is randomly selected, the known race for each racing entity (e.g., car) and the known finishing order or draw is played out. As a result, such systems only offer a finite number of “canned” races, and the attentive patron can detect a “re-run” of such races by identifying the starting order or what happens in the early stages, for example. For many patrons, this can become boring. Further, to the extent wagering may be placed after the start of such a race, the alert patron may obtain an unfair advantage over other patrons seeing the race for the first time.

### SUMMARY OF THE PRESENT INVENTION

The present invention provides a new system and method for offering draw-type racing animation games. The present invention can use a randomly selected outcome and work backwards to the starting point of a race, while randomly selecting events for each racing entity at each backwards step, as well as randomly selecting camera views of the race. Each random event and camera view is stored so that, when the race has been completely run in reverse, the system of the present invention can then render and display the race in forward direction so as to display a unique race every time. In one embodiment, the present invention can provide such games over a network for simultaneous viewing in different locations. In another embodiment, the present invention can accept wagers from viewers for the animated events. In another embodiment, the present invention displays the race in real-time, and does not use streaming video.

It will thus be seen that the present invention provides a racing game and method which can provide a unique race every time.

It will further be seen that the present invention provides a racing game and method that avoids predictability.

It will also be seen that the present invention provides a gaming engine for configuring a race in reverse for forward display.

It will further be seen that the present invention provides an event and camera angle randomizer for contributing variety to a race having a predetermined outcome.

It will further be seen that the present invention provides a method wherein the selection of random events is repeatable.

It will also be seen that the present invention provides a method for running a race in reverse from a predetermined outcome.

Other features and advantages of the invention will become apparent from the following detailed description, and from the claims.

### BRIEF DESCRIPTION OF THE DRAWINGS

FIG. 1 shows a diagram of an illustrative architectural configuration in accordance with one embodiment of the present invention.

FIG. 2 shows a block diagram of illustrative components of the gaming engine provided in accordance with one embodiment of the invention.

FIG. 3 shows a block diagram of the interaction of the various components in FIG. 2.

FIG. 4 shows an example track layout illustrating points where various events and conditions can be evaluated and displayed for a given race in accordance with one embodiment of the invention.

FIG. 5 is a flow chart showing the steps of providing a racing game in accordance with one embodiment of the present invention.

### DESCRIPTION OF THE PREFERRED EMBODIMENTS

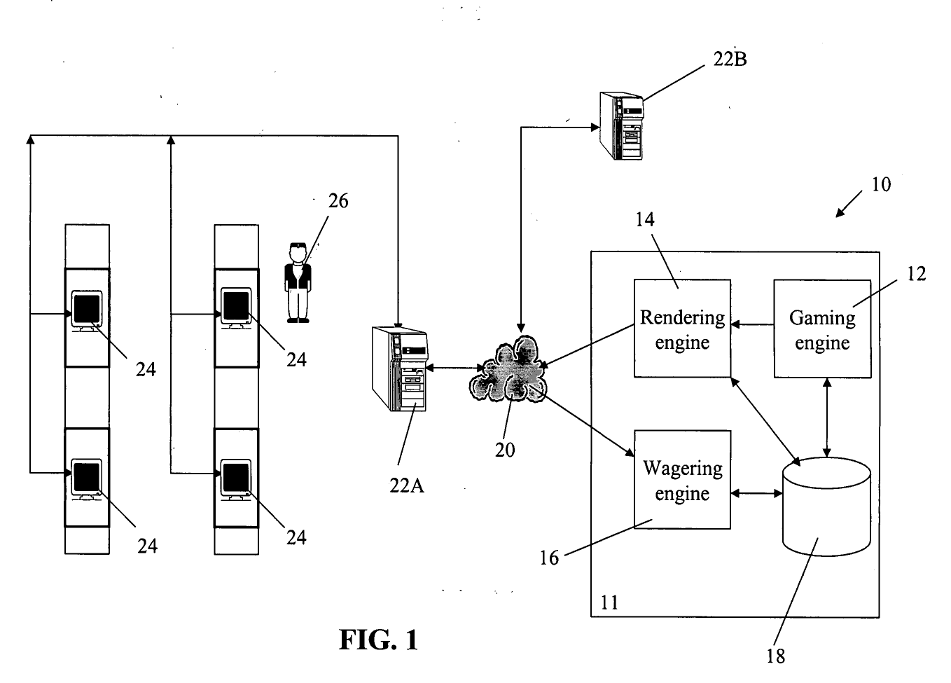

As shown in FIG. 1, the present invention provides a system 10 including a gaming engine 12, a rendering engine 14, a wagering engine 16 and a database 18. System 10 can comprise a host computer, remote or local, having software processes stored therein or on an accessible network for executing the programs in connection with the engines 12, 14 and 16. As further shown in FIG. 1, the system 10 can include and can be accessed through a local or wide area network 20, such as the Internet, for example, by one or more gaming location terminals or computers 22A, 22B so that produced racing animations can be displayed for viewers 26 at various locations 24 at the same time. In one embodiment of the invention, terminals 22A and 22B act as routers for passing the gaming information through to the appropriate display. For example, the present invention contemplates that gaming engine 12 may produce a horse race animation for certain displays associated with terminal 22A and an auto race animation for certain other displays associated with terminal 22A. In another embodiment of the present invention, network 20 is the Internet and terminals 22A and 22B are located in geographically distinct areas, obtaining race information from a host system for the same race.

It will be appreciated that system 10 can comprise the elements within host component 11 alone, or in combination with the networked terminals 22A and/or 22B and their associated displays. In one embodiment, host component 11 is maintained locally on site of an enterprise offering the racing game of the present invention, and can thereby allow for faster, real-time display of the produced video animation as described in more detail hereafter. One or more elements of host component 11 can be responsible for establishing a prize structure for races, which can establish and associate odds, expected number of winners and prize per winner with the number of successful matches for a given race. For example, if there are ten racing entities (e.g., cars) in a given race, the odds of successfully matching the order of the first three entities will be higher than the odds of successfully matching all ten racing entities. Accordingly, there will be fewer expected winners and a larger prize for matching all ten racing entities. A prize per winner, expected prize pool and expected prize payout can also be established and associated with a number of successful matches in connection with establishing a prize structure. Host component 11 can further be responsible for establishing any wager amounts, the time between draws, and the selection of variables which are configurable for each game.

As shown in FIGS. 1 through 3, gaming engine 12 is provided as part of system 10 and generates random scenarios associated with a given race type, such as through the selection of random numbers. In one embodiment of the invention, the finishing order of the number of objects (i.e., racing entities) is determined randomly (i.e., randomly selected), the “CDC” or random event number is determined randomly, and the event density, number of cameras, and camera angles are determined randomly. Event density relates to the percentage of time an event will occur per track section. In one embodiment of the invention, the random event number is a number randomly selected from a range of numbers from 1 to 2³², or 4,294,967,296 numbers, such as by using an algorithm, for example.

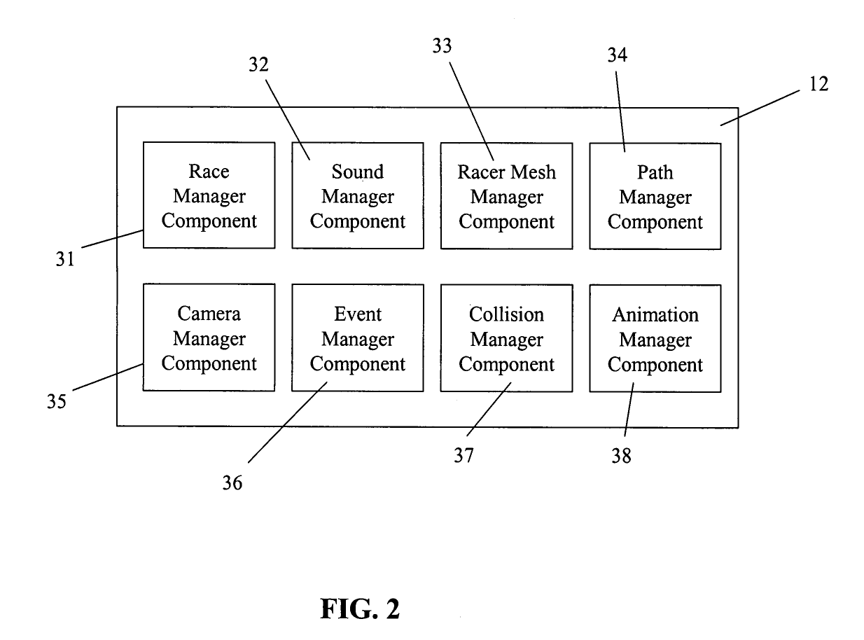

As shown in FIG. 2, the gaming engine can include various components and programming to effectuate one of the desired results of providing a completely random race with randomly determined outcome and randomly determined scenarios, events and camera angles. Gaming engine 12 is shown, in the example of FIG. 2, with a race manager component 31, a sound manager component 32, a racer mesh manager component 33, a path manager component 34, a camera manager component 35, an event manager component 36, a collision manager component 37 and an animation manager component 38. Components 31-38 may be software components or combination hardware/software components.

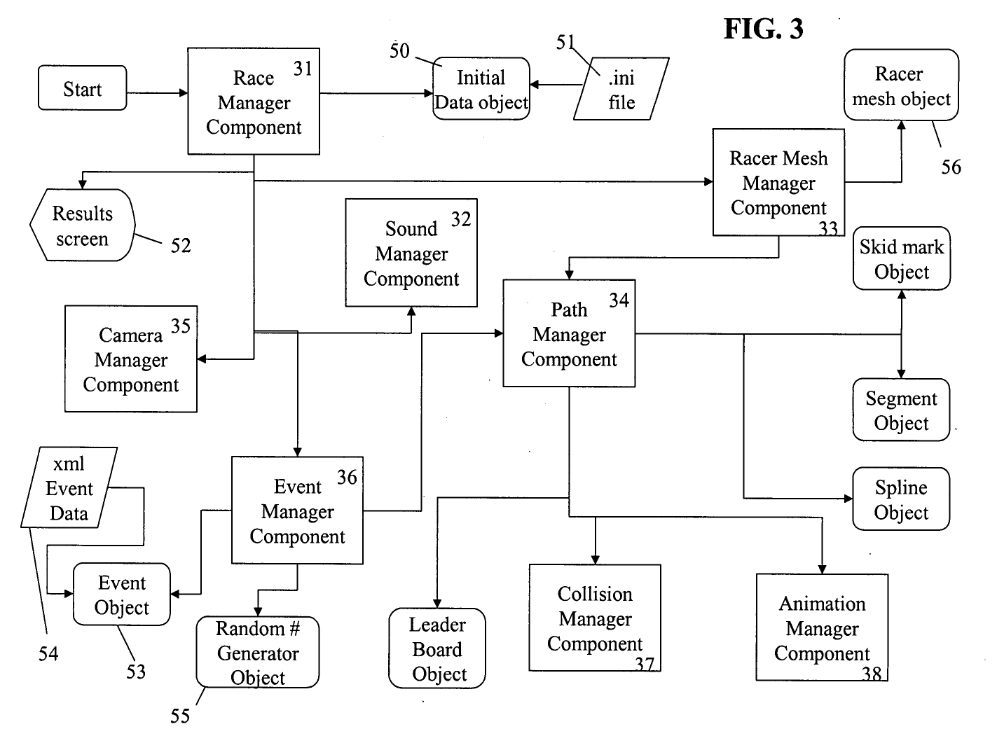

As shown in FIG. 3, the race manager component 31 helps create an initial data object 50 via an initialization file 51, wherein the data object 50 can be used by the remaining components to contribute various features to the given race being generated by the present invention. The initialization file provides an initial seed to the gaming engine related to an auto race or other type race to be generated, and the gaming engine uses the initial data object to generate random events, camera angles and associated ancillary features such as sound, collisions, etc. for storage in connection with the given race. As further shown in FIG. 3, the race manager component uses the initial data object to first determine the outcome of the given race, and a results screen can be generated as at 52. In one embodiment of the invention, the initialization can include such variables as the date and time of the race, the race number, the race properties (e.g., number of racing entities, duration of the simulation, duration of the post-game winning screen, time of day, number of laps for the race, event density, crash rate, event mask, number of cameras, event seed, etc.), the finishing order and a multiplier. The multiplier can be set as “on” or “off” and, if on, gauges the multiplier value for the race, which can result in a winning person's prize being multiplied according to the multiplier value.

Sound manager component 32 controls the sound for each race rendered according to the present invention. Racer mesh manager component 33 manages racing entity mesh objects for each racing entity, and can accommodate any form of racer oriented game. In one embodiment of the invention, this component 33 creates a racer mesh object for each racing entity, and can add or remove racer mesh as the race proceeds. For example, if a fatal event occurs for a given car during a given race, all of the objects associated with the “crashed” car will be removed by the racer mesh manager component 33 so that they no longer appear in the scene displayed.

Path manager component 34 manages the creation and maintenance of pointers to each of the racer mesh object's spline path data. Each racer mesh object can be provided with an individual path and can be constructed using vertex data located in the track scene graph, for example. Path manager component 34 can generate a path for each racer mesh object from this vertex data and is also responsible for updating the state of each racer mesh object. In one embodiment of the invention, a spline object is responsible for the actual movement of the racing entities around the track as well as the collision detection with the track.

In one embodiment of the invention, path manager component functions to retrieve, for each racing entity, the current segment object and event object for a given race segment. Based on what event is to happen, the path manager component performs the necessary tasks to make that event occur, whether it is a “passing” event, a “falling back” event, or visual events, for example. If there is no event, or when the event has been completed, a default behavior can be implemented for each racing entity, whereby the racing entity follows the track by an in and out fashion for the turns and straight-aways. Once all of the racing entities have been processed as such, the path manager component can repeat the function for the next segment.

Camera manager component 35 creates and maintains a list of cameras for the scene graph. Each time the present invention requires a camera to render the scene, it will be requested of and presented by the camera manager component 35. Event manager component 36 manages the events and event data for each race in accordance with the present invention. At startup, the event manager component can load a list of base events from an “.xml” data file, for example. Then, event manager component maintains a list of event objects and creates the sequence of race events for each of the car objects by randomly selecting events for each segment of the race track.

In one embodiment, the event manager component 36 creates all of the segment objects for each racing entity. Then, considering the number of race segments for the race, random events for each racing entity are selected based on which events are appropriate for the given segment of the race for each racing entity. After each event has been selected, the order of the racing entities can be displayed on a leader board, and is adjusted to reflect any events affecting the positions of the racing entities as determined by the event manager component 36. In one embodiment of the invention, event information can be established and stored as event types (e.g., pass, fall back, clip, failed pass, spin, move inside, move outside, crash, backfire, spark, blowout, etc.), event categories (e.g., a position event, a fatal event, a visual event, etc.), event dependencies (e.g., event can only occur if an inside/outside move has occurred, etc.) and visual event types. Events can also be created such that they occur only on given track segments (e.g., turn, straight-away, introduction, final segment) or on any segment. Events can also be created such that they can occur multiple times for a given racing entity (e.g., passing or falling back) or only a single time (e.g., tire blowout).

Collision manager component 37 manages all of the collision detection in each race. This component 37 can add objects for collision detection, and responds to collision detections. In one embodiment of the present invention, collision manager component 37 can operate in connection with each frame of a given race. Animation manager component 38 manages the animation. It loads the animation files and is responsible for starting and stopping animations for each car or racing entity. In one embodiment, each animation for each car or racing entity is held in a “.kf” file.

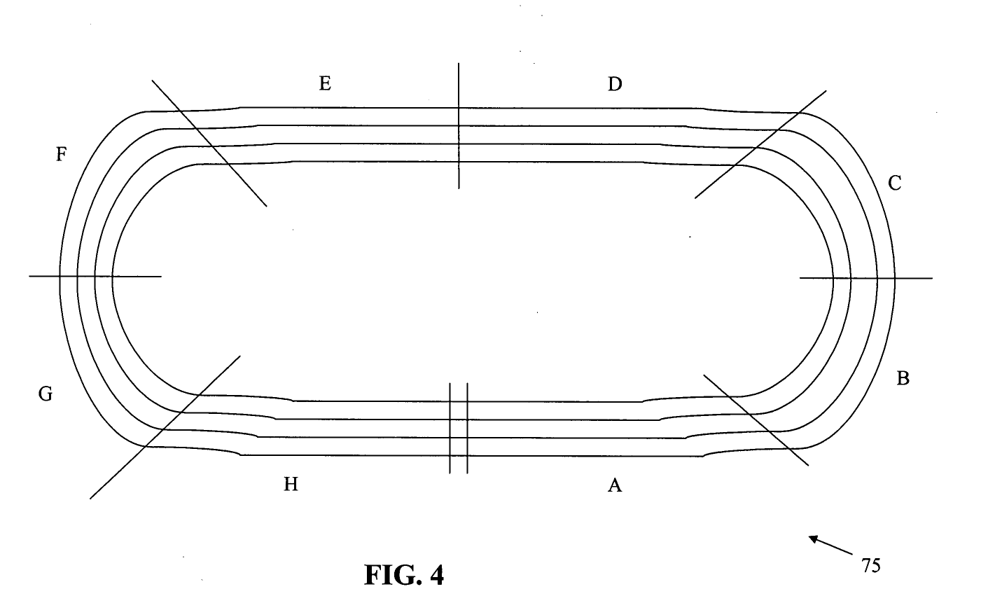

The race manager component 31 can use known randomizer methods for determining a draw or finishing order from among any number of racing entities (e.g., cars, horses, dogs, etc.). For example, if there will be ten cars participating in a given race which is to extend for three laps around a track such as track 75 shown in FIG. 4, the race manager component 31 can access programming appropriate for determining a random order of finish for the ten cars after the end of the third lap.

Once the draw is determined and stored, the gaming engine then begins to associate events, views, sounds and other features with the given race finish so that the finish image or video can be appropriately animated. For example, if the racing game of the present invention is provided with five separate camera views, the camera manager component 35 will use the initial data object as provided by the race manager component 31 to determine which of the five camera views will be provided for the race finish segment (i.e., video frames) of the given race. In an illustrative embodiment of the invention, the selection of the camera view is random and is determined by the initial data object. Similarly, the sound manager component 32 determines by random selection which of the available sounds for a given finish will be transmitted in association with the race finish segment. In one embodiment, the sound manager component 32 is influenced by the event manager component 36; thus, for example, if the event manager component determines that the race finish segment will include bumping of cars, the sound manager component 32 may be limited to a random selection of sounds associated with cars bumping. In another embodiment, as shown in FIG. 3, the sound manager component is not influenced by the event manager component determinations.

The event manager component 36 uses the initial data object 50 to determine events associated with given sections of the race. As shown in FIG. 4, a given race track can be divided into eight sections (labeled A through H), for example. Alternatively, the track can be divided into other sections, such as halves, quarters, furlongs, lengths or any dimensionally consistent span or period. Further, in one embodiment of the invention, the race is not produced according to track segments or periods, but rather by time periods.

The event manager component can provide as many or as few different events for each different racing entity as desired. In one embodiment, the present invention employs the event manager component to generate at least one event for each racing entity per track segment, for each lap associated with a given race. Thus, in a three-lap race over a track having eight sections, each racing entity will have twenty-four events randomly selected and associated with it. The event manager component 36 can build an event object 53 through available xml event data 54, and can also build a random number generator object 55 for use by the downstream components as shown in FIG. 3, for example. Thus, the event manager can determine an event to associate with the race finish segment, and in so doing, help determine additional elements of the racing display in accordance with the present invention.

As further shown in FIG. 3, the racer mesh manager component 33 can receive signals from the race manager component 31 to build a racer mesh object 56. This serves to define the three-dimensional frame or outer skeleton of each racing entity, and allows the present invention to define and know where the racing entity is in the three-dimensional environment. It will be appreciated that the racer mesh manager component can assist in improving the realistic appearance qualities of a wide variety of racing entities, including stock cars, Formula 1 cars, dragsters, horses, dogs, and other racing entity types.

As further shown in FIG. 3, the path manager component 34 receives signals from the event manager component 36 and racer mesh manager component 33 in order to build a skid mark object 57, segment object 58 and spline object 59. The skid mark object represents a tire skid mark in the three-dimensional world, which can be rendered programmatically in real time in one embodiment of the present invention. The segment object 58 pertains to a portion or segment of the track having data which contributes to the given event or racing entity for a given race. The spline object 59 contains data that contributes to the three-dimensional track configuration itself, such as an oval track configuration, S-shaped configuration, Figure-8-shaped configuration or other design configuration. It will be appreciated that, while some of the objects described in connection with FIG. 3 are typically associated automobile races, other objects can be developed in association with other types of races, or “skins”, such as horse races, dog races or other developed races. For example, in a horse race scenario, the path manager component 34 can be employed by the present invention to generate a dirt-kicking object or similar object as might appear in a horse race rendering.

The path manager component 34 then communicates with the collision manager component 37 and animation manager component 38 to build appropriate features which are consistent with the previously determined objects. Thus, after an event, camera view, ancillary event and/or appearance is determined for all racing entities for each segment, the animation manager can help build the animation for that segment involving all racing entities. The path manager component 34 can also build a leader board object, which allows viewers and/or participants to visually follow which racing entity is leading as well as the order of racing entities at each stage of the given race. The path manager component considers the events associated with each racing entity and the previous starting condition of each racing entity for the next segment. Because the race is initially constructed in reverse, the present invention considers future segment starting positions when determining positioning and event for previous segments, so that the race is fluid when eventually run in forward motion. Thus, the path manager component ensures that at the end of a given segment, a racing entity's path will match up with and/or align with the start of the path in the subsequent segment.

In one embodiment, the track path itself can comprise two spline curves, an inner curve, and an outer curve, wherein two adjacent points along a curve define a segment. The spline curves themselves can be interpolated such that the curve looks smooth everywhere and forms a circular pattern that passes through all points used. In one embodiment of the invention, the points chosen can come directly from the three-dimensional model of the track for both the inner and outer curves. The difference in height from a point on the inner curve to a point on the outer curve defines the roll for a car so that, on a banked corner, the racing entities (e.g., cars) will roll and follow the bank of the three-dimensional model. In an illustrative embodiment, in order to position a car along a point inside the two curves, three variables are determined—time, lateral offset and time offset. The time variable can be used as an input into the current event functions for each car to derive lateral offset and time offset. The time variable can also be used to position a reference point along the spline curve pair.

Using the reference point, the lateral offset can be used to move to the inside or the outside of the curve. The time offset can be used to move the point forward along the curve. The result can be a point somewhere in front of the reference point somewhere between the inside and outside of the curve. This is the current point used to compute the XYZ coordinates and HPR (heading, pitch, and roll) of the racing entity for the given time. In a preferred embodiment, the reference point always completes the race in a fixed amount of time, and all racing entities finish some amount of time before or equal to this point, thus guaranteeing race results in a fixed time.

It will be appreciated that all information relevant to the produced outcome is stored in database 18 for validation and authentication purposes of any wagering activity that may be accepted. Further, all of the sensory elements built in accordance with each stage or frame of the race are stored in database 18 as shown in FIG. 1. Thus, for example, if a particular frame or race segment involves a three-car crash, the appearance, sound, camera view, and any determined skid mark or other ancillary feature will be stored, along with the leader board notation for that particular frame or race segment.

Once the race finish segment and associated elements have been entirely determined and stored, the present invention proceeds, via the race manager component, to determine elements for the next preceding segment from the finish segment, and these elements are also stored. This reverse processing continues until the given race is drawn back to the starting line.

Referring back to FIG. 1, rendering engine 14 takes the results stored in database 18 and associated animations and builds a race in the forward direction. Rendering engine can employ any of various commercial technologies as known in the art to render high quality video images of the race animation. This race is then presented for local display on terminals 24.

Wagering engine 16 can also be provided as shown in FIG. 1 to accept wagers from participants 26 at terminals 24. Whether wagers are accepted only before a race or also during a race will depend upon the business rules applied by each entity choosing to incorporate wagering in connection with the present invention. In one embodiment, the wagering component can be linked (not shown) via network to an external wagering host (not shown) for tracking and managing all wagers pertaining to a given outcome.

In one embodiment, terminals 24 can conduct cash or credit transactions in exchange for gaming tickets or printouts of a user's wager, and can redeem and validate issued and authenticated tickets. Wagers can be consistent with the real-life wagering associated with the given race (e.g., “win”, “place”, “show” bets, as well as quiniella, trifecta, exacta, and “box” bets). In one embodiment of the invention, the terminal can be programmed to establish, deduct from and add to one or more wagering accounts maintained with the retail establishment or gaming provider. The terminal can be manned by human personnel or can be a stand-alone, self-service kiosk.

In one embodiment, the present invention can employ industry gaming technology as is known in the art for the development and display of the game.

### EXAMPLE OF OPERATION

In this example, the present invention is generating a race involving four cars, with five appearance types, five event types and five camera angle types. The race is to proceed around a track three times, with the track divided into eight segments as shown, for example, in FIG. 4. In determining scenes for playback, the system of the present invention begins with the result or output of the race, which has been randomly determined as described above. In connection with the determined finish order, the present invention also determines what appearance, event and camera angle will be associated with the finishing race segment.

From the point of the race finish, the present invention next considers how the segment just before the finish will appear. For instance, if Car 1 has been determined as the winner, and the finishing order of the four cars is Car 1, Car 3, Car 2, Car 4, then the segment before the finish can be randomized such that Car 2 was ahead of Car 3 for second place in the segment before the finish, and Car 4 bumps another car at the segment before the finish. For each car or racing entity, this method is applied for each segment beginning with the final segment and ending all the way back at the starting gate or starting line. In the process, each segment is adjusted as necessary for each car or racing entity such that the car or racing entity's position relative to the field is determined, as well as a randomly selected camera angle and randomly selected events or appearances affecting the car or racing entity.

Table 1 shows an example of the ordering of determination for various factors to be viewed in the playback. For example, in the “final segment” column, the present invention has determined the final ordering for four cars in the race, with each car having a randomly determined “appearance” as well as a randomly determined “event”.

TABLE 1

| Racing | Final Segment | | | | | | Beginning |
|---|---|---|---|---|---|---|---|
| Entity | (FS) | FS-1 | FS-2 | FS-3 | FS-4 | . . . | Segment |
| Car 1 | Place: 1 | Place: 1 | Place: 2 | Place: 3 | Place: 3 | . . . | Place: n/a |
| | Appearance: 2 | Appear: 4 | Appear: 3 | Appear: 2 | Appear: 1 | | Appear: 1 |
| | Event: 0 | Event: 0 | Event: 0 | Event: 0 | Event: 0 | | Event: n/a |
| Car 2 | Place: 3 | Place: 2 | Place: 3 | Place: 1 | Place: 2 | . . . | Place: n/a |
| | Appearance: 0 | Appear: 4 | Appear: 3 | Appear: 1 | Appear: 0 | | Appear: 4 |
| | Event: 0 | Event: 3 | Event: 0 | Event: 0 | Event: 1 | | Event: n/a |
| Car 3 | Place: 2 | Place: 3 | Place: 1 | Place: 2 | Place: 1 | . . . | Place: n/a |
| | Appearance: 2 | Appear: 0 | Appear: 4 | Appear: 3 | Appear: 1 | | Appear: 2 |
| | Event: 0 | Event: 3 | Event: 0 | Event: 0 | Event: 2 | | Event: n/a |
| Car 4 | Place: 4 | Place: 4 | Place: 5 | Place: 6 | Place: 6 | . . . | Place: n/a |
| | Appearance: 4 | Appear: 3 | Appear: 3 | Appear: 2 | Appear: 0 | | Appear: 4 |
| | Event: 0 | Event: 4 | Event: 3 | Event: 0 | Event: 0 | | Event: n/a |

Table 2 shows an example table of car “appearances”.

TABLE 2

| Appearance type | Description |
|---|---|
| 0 | Shiny |
| 1 | Dirty |
| 2 | Smoking |
| 3 | Braking |
| 4 | Accelerating |

Table 3 shows an example table of car “events”.

TABLE 3

| Event type | Description |
|---|---|
| 0 | Standard |
| 1 | Passing |
| 2 | Falling back |
| 3 | Bumping |
| 4 | Crashing |

In one embodiment of the invention, the random selection of the appearance and/or event factors is influenced by the desire to playback a realistic simulation; thus, the appearance or event factor may be restricted such that from any given frame to the frame previously before it, certain options are eliminated. For example, a car shown passing the remaining cars in segment N is not likely to have experienced a crash into the wall in segment N-1. Thus, the system of the present invention can adapt to remove certain options based on earlier determined events and/or appearances.

Table 4 shows an example listing of possible camera angles to be employed in connection with developing and rendering a given race in accordance with the present invention.

TABLE 4

| Camera Angle | Description |
|---|---|
| 0 | “Chase cam” |
| 1 | Look_at_cam_left |
| 2 | Look_at_cam_right |
| 3 | Side_follow_cam |
| 4 | Front_follow_cam |
| 5 | Ground_follow_cam |
| 6 | Blimp_cam |
| 7 | Stationary_cam |
| 8 | Flyover_cam |
| 9 | Front_cam |
| 10 | Chase_cam_back |
| 11 | Finish_cam |
| 12 | Intro_cam |

In one embodiment, the present invention does not provide different racing entity appearances, but rather provides randomly selected camera angles for each frame or racing segment. In a particular embodiment of the invention, camera angles stay on the screen for 5 second periods. It will be appreciated that many other appearance types, event type and camera angles can be applied beyond what is shown in the illustrative tables above. Such types and descriptions can be affected by the type of racing entity (e.g., horses, stock cars, Formula 1 racing cars, dragsters, dogs, etc.), as well as the length and complexity of the given race. Camera angles can be balanced throughout a given race, such that close-up action views and distant “field” views are properly balanced and patrons remain interested throughout the duration of the race.

When the present invention proceeds with playing the outcome, the full motion simulation appears as a forward running video as is known in the art. However, the camera views have been randomized, the car positioning has been randomized, the car “events” have been randomized, the car appearance has been randomized and the final ordering has been randomized, all in reverse. The playback can appear on multiple screens or displays at multiple locations at the same time; thus, the present invention can provide a simulcast of the race and thereby allow more wagering on each play.

An example playback in connection with a car race can occur as follows:

The game opens up displaying a green flag background with the race number and three-second countdown to the start. A flag wipes across the screen for two seconds to reveal start of the race. As the flag crosses the screen, the cars are revealed side by side (two per row) coming out of turn four approaching the start/finish line. At the same moment the green flag clears the screen, the engines power up and reach maximum volume, synchronizing with the first two cars crossing the start line. As the cars enter turn one, the car on the inside of the front row pulls ahead while the car on the outside of the front row moves in behind him.

Cars in the next row do a similar thing, while cars further back in the field stay basically side by side. As the cars exit turn two onto the backstretch, one or more cars begin passing further back in the pack. Entering turn three, a car goes high and gets passed, ending up at the back of the pack. Coming off turn four, the car in second place gets a good bite off the corner and pulls into the lead. Another pass or two occurs on the front stretch. Entering turn one, two cars in the middle of the pack bang into each other, bouncing off each other but maintaining position. Leaving turn two, one car gets loose and fishtails a little, causing him to lose a couple of positions. Again more passing occurs on the back stretch throughout the field. Cars run through turns three and four fairly cleanly, mostly single file with some cars staggered. Exiting turn four, a car near the front goes too wide and scrapes the wall, causing him to slow and lose several positions.

As the cars cross the start/finish line, the white flag is waved indicating the last lap. Approaching turn one, the second place car passes the first place car on the outside and reaches the corner first. In the middle of the field, an inside car clips the back end of a car on its outside and sends him high in the corner, causing him to lose several spots. Leaving turn two, a car near the front of the field begins smoking and falls all the way to the last place; the car continues to circle the track but at a reduced speed, clearly finishing in last place. Several passes take place on the back stretch with some cars passing each other only to be re-passed before turn three. Multiple cars bump and bang through turns three and four as the field tightens up for the last sprint to the finish. Exiting turn four, the three lead cars come off almost head to head, each edging forward on the last stretch before the finish. Just before the cars cross the finish line, the winner pulls ahead for the last time. As the winner crosses the finish line, a checkered flag appears from the area of the screen that the green flag disappeared into and sweeps across the screen (e.g., two seconds). As the checkered flag fills the screen, the scoring pole appears showing the final positions of all cars for, e.g., five seconds.

In such a race, the total time can be, for example, 45 seconds, with five seconds for start activities, seven seconds for finish activities, and three laps at eleven seconds each. Average time can also be approximately 2.5 seconds on each straightaway and approximately three seconds in each pair of turns.

It will thus be seen that the present invention can achieve purely random “uncanned” playback with no two races alike. Literally millions of outcomes and event combinations are available for rendering by the present invention. Accordingly, the present invention adds to the entertainment value, and removes any predictability of the outcome of the race based on early sensory impressions of the race. Further, the risk of associated wagering being tainted by users who have been exposed to the “canned” races of other systems is eliminated.

In one embodiment, the present invention can be incorporated as part of a display or wagering machine having other games or races thereon. In this way, the footprint of the physical embodiment of the device can be limited so that retailers can save space.

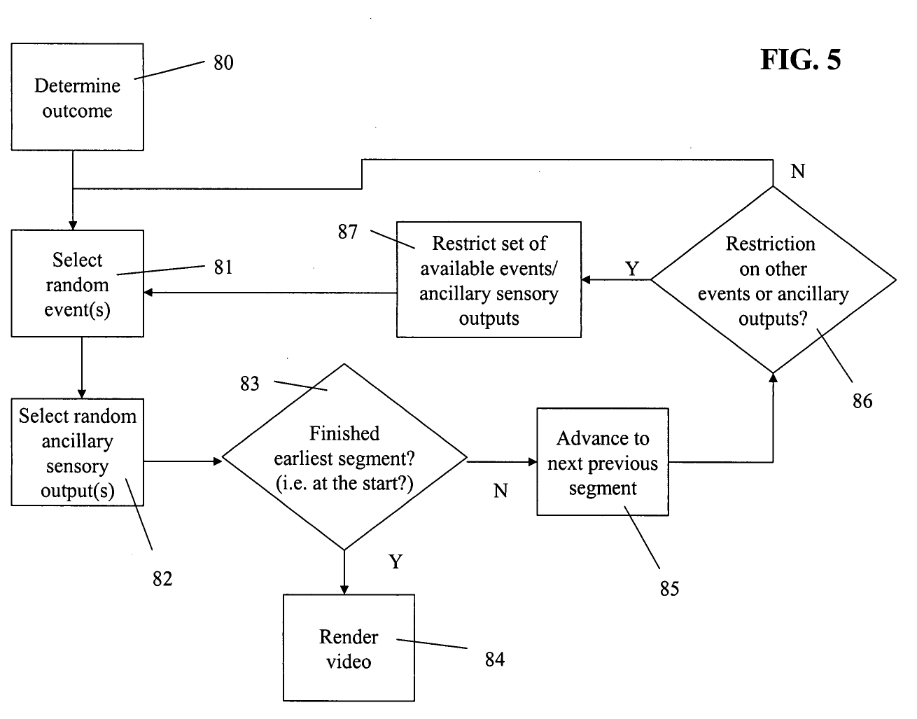

A method of rendering the racing game in accordance with one embodiment of the present invention is shown in FIG. 5. As shown at step 80, the outcome or draw is determined as described above. For the given race segment, an event is randomly selected for one or more of the racing entities involved in the race, as at step 81. An ancillary sensory output element can then be randomly selected for one or more of the racing entities, as at step 82. This can be a camera angle selection, a racing entity appearance selection, a sound and so forth. At step 83, the system determines whether this is the earliest race segment, i.e., the beginning of the race, and if so, the system collects the stored data about the race and renders the video animation, as at step 84. If not, the system advances to the next previous race segment as at step 85. The system can then determine, as at step 86, whether this previous race segment may be restricted in what it can reveal in the sense of events or ancillary sensory features, based on what event may have transpired in the previous determination (for what becomes the later race segment when the video is viewed in the forward running mode). If so, then the system restricts the set of available events and/or ancillary features as at step 87, and returns to select a random event or ancillary output from the restricted set. If not, then the system returns to step 81 to select a random event and then a random ancillary output as at step 82 for this next preceding race segment.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system. The present invention can further run on a variety of platforms, including Microsoft Windows™, Linux™, or other platforms, for example.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

What is claimed is:

1. A computer-assisted method of rendering a race animation involving a plurality of racing entities and a race track, comprising the steps of:
determining a random finishing order of the racing entities participating in said race;
determining a number of time periods or track periods associated with said race;
determining, for each racing entity, a random event associated with each of said time periods or track periods;
determining, for each of said time periods or track periods, a random camera angle from which to view said race; and
rendering said race in animation.

2. The method of claim 1 wherein said step of determining a number of periods involves determining a number of track periods, wherein said periods are taken from the period types consisting of: track lengths, track halves, track furlongs, track quarters, track quadrants, or track eighths.

3. The method of claim 1 wherein said step of determining a number of periods involves determining a number of time periods, and wherein said time periods are in seconds.

4. The method of claim 1 wherein said step of determining a finishing order includes the step of randomly selecting from among a group of possible finishing orders.

5. The method of claim 1 wherein said step of determining an event includes the step of randomly selecting from among a group of possible events.

6. The method of claim 5 wherein said group of possible events is populated by considering one or more previous events associated with said racing entity.

7. The method of claim 1 wherein said step of determining a camera angle includes the step of randomly selecting from a group of possible camera angles.

8. The method of claim 1 including the further step of, prior to said rendering step, determining for each of said entities, an ancillary sensory output associated with each of said time periods or track periods.

9. The method of claim 1 wherein said step of determining an event for each entity includes the step of, after each determined event for said time period or track period, rendering an animation showing said event in connection with said entity and storing said rendered animation.

10. The method of claim 9 wherein said step of rendering said race in animation includes arranging each of said rendered animations for each entity for each of said time or track periods into a forward motion video animation.

11. A system for rendering a race animation involving a plurality of racing entities and a race track, comprising:
means for determining a random finishing order of the racing entities participating in said race;
means for determining a number of time periods or track periods associated with said race;
means for determining, for each racing entity, a random event associated with each of said time periods or track periods;
means for determining, for each of said time periods or track periods, a random camera angle from which to view said race; and
means for rendering said race in animation.

12. The system of claim 11 wherein said means for determining a number of periods includes means for determining a number of track periods, wherein said periods are taken from the period types consisting of: track lengths, track halves, track furlongs, track quarters, track quadrants, or track eighths.

13. The system of claim 11 wherein said means for determining a number of periods includes means for determining a number of time periods, and wherein said time periods are in seconds.

14. The system of claim 11 wherein said means for determining a finishing order includes means for randomly selecting from among a group of possible finishing orders.

15. The system of claim 11 wherein said means for determining an event includes the means for randomly selecting from among a group of possible events.

16. The system of claim 15 wherein said group of possible events is populated by considering one or more previous events associated with said racing entity.

17. The system of claim 11 wherein said means for determining a camera angle includes means for randomly selecting from a group of possible camera angles.

18. The system of claim 11 including means for determining, for each of said entities, an ancillary sensory output associated with each of said time periods or track periods.

19. The system of claim 11 wherein said means for determining an event for each entity includes means for rendering an animation showing said event in connection with said entity and means for storing said rendered animation.

20. The system of claim 19 wherein said means for rendering said race in animation includes means for arranging each of said rendered animations for each entity for each of said time or track periods into a forward motion video animation.

21. A system for providing a real-time randomized race animation, comprising:
a gaming engine having:
a race manager component for randomly selecting a finishing order of racing entities in said race animation;
a camera manager component for determining a camera view or views associated with at least two stages of said race animation;
an event manager component for determining an event associated with each of said racing entities for at least two stages of said race animation;
a path manager component for determining a path associated with each of said racing entities;
a racer mesh component for providing an animation framework for each of said racing entities; and
an animation manager component for rendering animations of each of said stages for each of said racing entities after said event has been determined; and
a rendering engine for compiling the rendered animations into a forward race animation.

22. The system of claim 21 wherein said gaming engine further includes a sound manager component.

23. The system of claim 21 wherein said gaming engine further includes a collision manager component.

24. A computer-assisted method of rendering a race simulation, comprising the steps of:
determining a random order of finish for a plurality of racing entities;
determining, in reverse of said order of finish, a plurality of events associated with one or more of said racing entities up to a determined start of said race simulation;
producing signals of video images corresponding to said outcome and said event determinations; and
distributing said signals to one or more display terminals for playback from said start to said finish.

25. The method of claim 24 wherein said display terminals are associated with different facilities in different locations.

26. The method of claim 24 wherein said plurality of events are random events.

27. The method of claim 24 wherein said step of determining a random order of finish for a plurality of racing entities is in connection with a plurality of different races, and wherein said distributing step includes distributing signals associated with a first race to a first display terminal, and distributing signals associated with a second race to a second display terminal.

28. The method of claim 24 wherein said step of determining a plurality of events pertains to a given race segment, and includes determining a path starting point for each of said racing entities in connection with a subsequent race segment closer to said finish than said given race segment.
